(19) United States
(12) Patent Application Publication
(10) Pub. No.: US 2026/0321578 A1
(43) Pub. Date: Oct. 15, 2026

(54) CYLINDRICAL LITHIUM PRIMARY BATTERY

(71) Applicant: Panasonic Intellectual Property Management Co., Ltd., Osaka (JP)

(72) Inventors: RYUSUKE MIZUKAMI, Osaka (JP); FUTOSHI TANIGAWA, Osaka (JP); YASUNOBU KODAMA, Hyogo (JP)

(21) Appl. No.: 19/484,531

(22) PCT Filed: Jan. 26, 2024
(86) PCT No.: PCT/JP2024/002388

§ 371 Date: Nov. 14, 2025

(30) Foreign Application Priority Data
May 31, 2023 (JP) 2023-090213

(51) Int. Cl. H01M 4/06; H01M 4/38; H01M 4/66; H01M 50/107

(52) U.S. Cl. CPC H01M 4/06; H01M 4/382; H01M 4/661; H01M 50/107

(57) ABSTRACT

The disclosed cylindrical lithium primary battery includes an electrode group formed by winding a positive electrode, a negative electrode, and a separator. The outermost circumference of the negative electrode is disposed outside the outermost circumference of the positive electrode. The negative electrode includes first and second metal foils and a conductive sheet. The first metal foil and the second metal foil are each made of lithium metal or a lithium alloy. A ratio T2/T1 of a thickness T2 of the second metal foil to a thickness T1 of the first metal foil is 0.30 or more and less than 1.00. At least a part of the outermost circumference of the negative electrode is formed of the second metal foil. The conductive sheet is connected to an outer circumferential surface of an outermost circumferential end portion of the first metal foil and an outer circumferential surface of an innermost circumferential end portion of the second metal foil. At least a part of the outermost circumference of the positive electrode faces the second metal foil with the separator interposed therebetween.

### TECHNICAL FIELD

The present disclosure relates to a cylindrical lithium primary battery.

### BACKGROUND ART

Lithium primary batteries are used in many electronic devices because of their high energy density and low self-discharge. Conventionally, various cylindrical lithium primary batteries have been proposed.

Claim 1 of Patent Literature 1 (JP 2012-138225 A) describes “a cylindrical nonaqueous electrolyte primary battery including an electrode group having a winding structure in which a positive electrode containing manganese dioxide and a negative electrode are spirally wound with a separator interposed therebetween, wherein the negative electrode includes a metal lithium-containing layer formed of only one continuous layer on one surface of a current collector, the metal lithium-containing layer covers 85% or more of an area of a surface of the current collector on which the metal lithium-containing layer is formed, and a lithium-aluminum alloy is formed on at least a part of a surface of the metal lithium-containing layer on a side opposite to the current collector”.

Claim 1 of Patent Literature 2 (Japanese Unexamined Patent Application Publication No. H11-242961) describes “a method for manufacturing a nonaqueous electrolyte battery in which a strip-shaped lithium negative electrode formed of lithium or a lithium alloy in a sheet shape and a strip-shaped positive electrode are spirally wound via a separator to form a spiral electrode group, and the spiral electrode group is inserted into an outer can together with a nonaqueous electrolyte to form the nonaqueous electrolyte battery, the method including: a negative electrode forming step including a step of forming a long-side first lithium negative electrode and a step of forming a short-side second lithium negative electrode having a length shorter than that of the first lithium negative electrode; a negative electrode attaching step of attaching the first lithium negative electrode and the second lithium negative electrode to a separator so as to be aligned in a longitudinal direction of the separator; a separator bending step of bending the separator so that one end of the first lithium negative electrode and one end of the second lithium negative electrode overlap each other; and a spiral electrode group forming step of overlapping the strip-shaped positive electrode with the separator bent in the separator bending step and then spirally winding the resultant so that the strip-shaped positive electrode is located inside to form the spiral electrode group, in which a portion of the first lithium negative electrode having a length longer than that of the second lithium negative electrode becomes an outermost circumferential portion of the spiral electrode group when the spiral electrode group is formed”.

Claim 1 of Patent Literature 3 (JP 2016-122592 A) describes “a spiral-type lithium battery in which a strip-shaped electrode group in which a negative electrode containing lithium metal or a lithium alloy as a negative electrode active material is disposed so as to face a positive electrode with a separator interposed therebetween is sealed together with a non-aqueous organic electrolytic solution in a bottomed cylindrical battery can serving as a negative electrode current collector in a state of being wound in a longitudinal direction, wherein the electrode group is wound so that the negative electrode is disposed on an outermost circumference with a winding axis as a winding start, and a conductor continuous in a longitudinal direction of the electrode group is attached to an outer circumferential surface of the negative electrode from a winding end portion to a region facing an inner surface close to the winding end of the positive electrode”.

### CITATION LIST

### Patent Literature

Patent Literature 1: Unexamined Japanese Patent Publication No. 2012-138225

Patent Literature 2: Unexamined Japanese Patent Publication No. H11-242961

Patent Literature 3: Unexamined Japanese Patent Publication No. 2016-122592

### SUMMARY

Cylindrical lithium primary batteries are required to have an improved discharge capacity without increasing the defect rate during production.

A cylindrical lithium primary battery according to one aspect of the present disclosure includes an electrode group formed by winding a positive electrode, a negative electrode, and a separator in a circumferential direction with the separator disposed between the positive electrode and the negative electrode. In the electrode group, an outermost circumference of the negative electrode is disposed outside an outermost circumference of the positive electrode. The negative electrode includes a first metal foil, a second metal foil, and a conductive sheet. Each of the first metal foil and the second metal foil is made of lithium metal or a lithium alloy. A length of the second metal foil in the circumferential direction is shorter than a length of the first metal foil in the circumferential direction. The thickness T2 of the second metal foil is smaller than the thickness T1 of the first metal foil. A ratio T2/T1 of the thickness T2 to the thickness T1 is 0.30 or more. The first metal foil and the second metal foil are arranged side by side in the circumferential direction such that the first metal foil has a first innermost circumferential end portion and a first outermost circumferential end portion and the second metal foil has a second innermost circumferential end portion and a second outermost circumferential end portion. At least a part of the outermost circumference of the negative electrode is formed of the second metal foil. The conductive sheet is connected to an outer circumferential surface of the first outermost circumferential end portion of the first metal foil and an outer circumferential surface of the second innermost circumferential end portion of the second metal foil. At least a part of the outermost circumference of the positive electrode faces the second metal foil via the separator.

In the present disclosure, it is possible to obtain a cylindrical lithium primary battery in which the discharge capacity is improved and the defect rate during the production thereof has been decreased.

### BRIEF DESCRIPTION OF DRAWINGS

FIG. 1A is a cross-sectional view schematically showing a cylindrical lithium primary battery according to a first embodiment.

FIG. 1B is a diagram schematically illustrating an example of a part of a cross section taken along line IB-IB in FIG. 1A.

FIG. 2A is a top view schematically showing an example of a negative electrode produced in Examples.

FIG. 2B is a diagram schematically showing a cross section of the negative electrode shown in FIG. 2A.

FIG. 3A is a top view schematically illustrating another example of a negative electrode produced in Examples.

FIG. 3B is a diagram schematically showing a cross section of the negative electrode shown in FIG. 3A.

FIG. 4A is a top view schematically showing another example of the negative electrode produced in Examples.

FIG. 4B is a diagram schematically showing a cross section of the negative electrode shown in FIG. 4A.

FIG. 5A is a top view schematically showing another example of the negative electrode produced in Examples.

FIG. 5B is a diagram schematically showing a cross section of the negative electrode shown in FIG. 5A.

FIG. 6A is a top view schematically showing another example of the negative electrode produced in Examples.

FIG. 6B is a diagram schematically showing a cross section of the negative electrode shown in FIG. 6A.

FIG. 7A is a top view schematically showing another example of the negative electrode produced in Examples.

FIG. 7B is a diagram schematically showing a cross section of the negative electrode shown in FIG. 7A.

FIG. 8A is a top view schematically showing another example of the negative electrode produced in Examples.

FIG. 8B is a diagram schematically showing a cross section of the negative electrode shown in FIG. 8A.

FIG. 9A is a top view schematically showing another example of the negative electrode produced in Examples.

FIG. 9B is a diagram schematically showing a cross section of the negative electrode shown in FIG. 9A.

FIG. 10 is a diagram showing evaluation results of Examples of the cylindrical lithium primary battery according to the embodiment.

FIG. 11 is a diagram showing evaluation results of Examples of the cylindrical lithium primary battery according to the embodiment.

### DESCRIPTION OF EMBODIMENT

Hereinafter, an embodiment according to the present disclosure will be described with examples, but the present disclosure is not limited to the examples described below. In the following description, specific numerical values and materials may be exemplified, but other numerical values and other materials may be applied as long as the effects of the present disclosure are obtained. In the present specification, the expression “numerical value A to numerical value B” includes the numerical value A and the numerical value B, and can be read as “numerical value A or more and numerical value B or less”. In the following description, when lower limits and upper limits of numerical values relating to specific physical properties and conditions are exemplified, any of the exemplified lower limits and any of the exemplified upper limits can be arbitrarily combined as long as the lower limit is not equal to or greater than the upper limit. In the following description, when examples of constituent elements or examples of methods are listed, only one of the listed examples may be used or a plurality of the listed examples may be used in combination unless otherwise specified.

### (Cylindrical Lithium Primary Battery)

Hereinafter, the cylindrical lithium primary battery according to the present embodiment may be referred to as a “lithium primary battery (B)”. The lithium primary battery (B) includes an electrode group formed by winding a positive electrode, a negative electrode, and a separator such that the separator is disposed between the positive electrode and the negative electrode. The outermost circumference of the negative electrode is disposed outside the outermost circumference of the positive electrode. The negative electrode includes a metal foil and a conductive sheet. The metal foil is divided into a first metal foil and a second metal foil. The first metal foil and the second metal foil are each made of lithium metal or a lithium alloy. The length of the second metal foil in the circumferential direction is shorter than the length of the first metal foil in the circumferential direction. The thickness T2 of the second metal foil is smaller than the thickness T1 of the first metal foil. A ratio T2/T1 of the thickness T2 to the thickness T1 is 0.30 or more. The first metal foil and the second metal foil are arranged side by side in the longitudinal direction of the negative electrode. At least a part of the outermost circumference of the negative electrode is formed of the second metal foil. The conductive sheet is connected to an outer circumferential surface of an outermost circumferential end portion which is a winding end side of the first metal foil and an outer circumferential surface of an innermost circumferential end portion which is a winding start side of the second metal foil. At least a part of the outermost circumference of the positive electrode faces the second metal foil with the separator interposed therebetween.

In the present specification, the outermost circumference of the negative electrode means one outermost turn of the wound negative electrode. Similarly, the outermost circumference of the positive electrode means one outermost turn of the wound positive electrode. The electrode group starts to be wound from the central axis thereof. Therefore, the winding start side means an inner circumferential side close to a portion serving as the central axis of the electrode group when the electrode group is unwound. In addition, the winding end side means an outer circumferential side close to a portion which becomes an outer circumferential end portion of the electrode group when the electrode group is unwound. In the present specification, the “length in the circumferential direction” means a length along the circumferential direction of the winding. The “length in the circumferential direction” is equal to the length when the wound electrode is extended flat. As described above, the outermost circumference of the negative electrode is disposed outside the outermost circumference of the positive electrode. In other words, the outermost circumference of the negative electrode is wound outside the outermost circumference of the positive electrode. In one example, the outermost circumference of the positive electrode faces the outermost circumference of the negative electrode with the separator interposed therebetween.

The negative electrode includes a negative electrode active material portion (first metal foil, second metal foil) and a conductive sheet. The first metal foil is disposed on the innermost circumferential portion which is the winding start side of the negative electrode active material portion, and the second metal foil is disposed on the outermost circumferential portion which is the winding end side of the negative electrode active material portion. The entire outermost circumference of the negative electrode is disposed outside (on the outer circumferential side of) the outermost circumference of the positive electrode. The conductive sheet is connected to the outer circumferential surface of the first metal foil and the outer circumferential surface of the second metal foil. The conductive sheet may be connected to the outer circumferential surface of the outermost circumferential portion on the winding end side of the first metal foil and the outer circumferential surface of the second metal foil. The conductive sheet may be connected to the outer circumferential surface of the outermost circumferential portion on the winding end side of the first metal foil and the outer circumferential surface of the innermost circumferential portion on the winding start side of the second metal foil.

Only one surface of the outermost circumference of the negative electrode faces the positive electrode with the separator interposed therebetween. Therefore, when the thickness of the negative electrode on the outermost circumference is made equal to the thickness of the negative electrode on the inner circumference side, the negative electrode active material (lithium-containing metal) on the outermost circumference becomes excessive. In the lithium primary battery (B), since the average thickness T2 of the second metal foil located at the outermost circumference of the negative electrode is smaller than the average thickness T1 of the first metal foil, the positive electrode active material and the negative electrode active material can be balanced, and the discharge capacity can be improved.

The conductive sheet of the lithium primary battery (B) may have any size as long as the conductive sheet can connect the first metal foil and the second metal foil. Therefore, unlike Patent Literature 1, it is possible to increase the ratio of the volume of the negative electrode active material (lithium-containing metal foil) to the volume of the entire negative electrode. Therefore, the discharge capacity can be increased.

Furthermore, unlike Patent Literature 1 in which a current collector and a metal lithium-containing layer having substantially the same size are bonded to each other, in the lithium primary battery (B), positional displacement is less likely to occur when the first metal foil and the second metal foil are connected to each other with the conductive sheet. In the lithium primary battery (B), the first metal foil and the second metal foil are arranged side by side in the longitudinal direction. Therefore, in the production of the lithium primary battery (B), it is possible to suppress occurrence of defects such as winding deviation, and as a result, it is possible to decrease the defect rate. As described above, in the lithium primary battery (B), it is possible to achieve improvement of the discharge capacity and the decrease in the defect rate during the production thereof in a well-balanced manner.

The first metal foil and the second metal foil are each made of a lithium-containing metal. The lithium-containing metal is lithium (lithium metal) or a lithium alloy.

The first metal foil has an innermost circumferential end portion E1inn on the winding start side and an outermost circumferential end portion E1out on the winding end side. The second metal foil has an innermost circumferential end portion E2inn on the winding start side and an outermost circumferential end portion E2out on the winding end side. The outermost circumferential end portion is a portion including an outermost circumferential end, and the innermost circumferential end portion is a portion including an innermost circumferential end.

The ratio T2/T1 of the thickness T2 of the second metal foil to the thickness T1 of the first metal foil is 0.30 or more, and may be 0.40 or more. The ratio T2/T1 is less than 1.00, and may be 0.90 or less, 0.80 or less, 0.70 or less, or 0.60 or less. The ratio T2/T1 may be in the range 0.30 to 0.80 (e.g., in the range 0.40 to 0.60).

The thickness T1 of the first metal foil is usually constant. Similarly, the thickness T2 of the second metal foil is usually constant. When the thickness of the first metal foil varies depending on the location, the following average thickness may be deemed to be the thickness T1. First, the first metal foil is divided into five equal parts in the longitudinal direction thereof, and the thickness of any one portion of each part is measured. Then, a value obtained by arithmetically averaging the measured thicknesses at the five locations is defined as the thickness T1. When the thickness of the second metal foil varies depending on the location, the average thickness obtained by the same procedure may be used as the thickness T2.

The lithium primary battery (B) may satisfy the following conditions (1) and/or (2), where the length Lout, the length L2a, and the length L2 are lengths along the circumferential direction of the electrode group, respectively.

(1) A ratio L2a/Lout of a length L2a of a portion of the second metal foil facing the outermost circumference of the positive electrode with the separator interposed therebetween to a length Lout of the outermost circumference of the positive electrode is 0.5 or more.

(2) The ratio L2/Lout of the length L2 of the second metal foil to the length Lout of the outermost circumference of the positive electrode is 1.5 or less.

The ratio L2a/Lout may be 0.7 or more. The ratio L2a/Lout is 1.0 or less. When the ratio L2a/Lout is 0.5 or more, half or more of the outermost circumference of the positive electrode faces the second metal foil. When the ratio L2a/Lout is 0.5 or more, the positive electrode active material and the negative electrode active material at the outermost circumference of the positive electrode are easily balanced.

The ratio L2/Lout may be 1.3 or less. By bringing the ratio L2/Lout close to 1.0, the positive electrode active material and the negative electrode active material at the outermost circumference of the positive electrode are easily balanced.

The innermost circumferential end portion E2inn on the winding start side of the second metal foil may extend in the inner circumferential direction Dp1, which is a winding start side, from the outermost circumferential end portion on the winding start side of the outermost circumference of the positive electrode. However, the balance between the positive electrode capacity and the negative electrode capacity in the electrode group is likely to be lost due to the extension. Therefore, the length of the second metal foil extending in the inner circumferential direction Dp1, which is a winding start side, from the innermost circumferential end portion on the winding start side of the outermost circumference of the positive electrode is preferably shorter.

The outermost circumferential end portion E2out on the winding end side of the second metal foil may be located at a position facing the outer circumferential side of the outermost circumferential end portion Eout on the winding end side of the positive electrode. The second metal foil may extend further in the winding end direction Dp2 from the position facing the outer circumferential side of the outermost circumferential end portion Eout. That is, when the ratio L2/Lout is 1.0 or more, the following conditions (1) and/or (2) may be satisfied.

(1) The innermost circumferential end portion E2inn is located at a position in the inner circumferential direction Dp1, which is a winding start side, from the position facing the inner circumference side of the outermost circumferential end portion Eout.

(2) The outermost circumferential end portion E2out is located at a position in the outer circumferential direction Dp2, which is a winding end side, from the position facing the outer circumferential side of the outermost circumferential end portion Eout.

The lithium primary battery (B) preferably satisfies at least one selected from the group consisting of the following conditions (1) to (3). For example, the conditions (1) and (2) may be satisfied, the conditions (1) and (3) may be satisfied, the conditions (2) and (3) may be satisfied, or all of the conditions (1) to (3) may be satisfied.

(1) 50% or more (in the range of 50 to 100%) of the area of the outer circumferential surface of the outermost circumference of the positive electrode faces the inner circumferential surface of the second metal foil with the separator interposed therebetween.

(2) The ratio Ls/Lout of the length Ls of the conductive sheet to the length Lout of the outermost circumference of the positive electrode is 0.3 or more or 0.5 or more, and 1.5 or less or 1.2 or less.

(3) The ratio Ld/Lout of the length Ld between the first metal foil and the second metal foil to the length Lout of the outermost circumference of the positive electrode is 0 or more or 0.1 or more, and 0.4 or less or 0.2 or less.

Here, each of the length Ls and the length Ld is a length in the circumferential direction of the electrode group. When the first metal foil and the second metal foil are arranged without a gap, and when a part of the first metal foil and a part of the second metal foil overlap each other, Ld/Lout=0.

Eighty % or more (for example, 90% or more or 95% or more) of the area of the outer circumferential surface of the outermost circumference of the positive electrode may face the inner circumferential surface of the second metal foil with the separator interposed therebetween. The entire outer circumferential surface of the outermost circumference of the positive electrode may face the inner circumferential surface of the second metal foil with the separator interposed therebetween.

As described above, the ratio Ls/Lout may be in the range of 0.3 to 1.5 (e.g., in the range of 0.5 to 1.2). By decreasing the ratio Ls/Lout, the discharge capacity can be particularly increased. By increasing the ratio Ls/Lout, strong connection between the first metal foil and the second metal foil is facilitated.

As described above, the ratio Ld/Lout may be in the range of 0 to 0.4 (for example, in the range of 0.1 to 0.2).

The ratio Ws/W1 of the width Ws of the conductive sheet to the width W1 of the first metal foil may be 0.3 or more or 0.5 or more, and may be 1.0 or less or 0.8 or less. That is, the ratio Ws/W1 may be in a range of 0.3 to 1.0 (for example, in a range of 0.5 to 0.8). By decreasing the ratio Ws/W1, the discharge capacity can be particularly increased. By increasing the ratio Ws/W1, strong connection between the first metal foil and the second metal foil is facilitated.

In the lithium primary battery (B), the outermost circumferential end portion E1out on the winding end side of the first metal foil and the innermost circumferential end portion E2inn on the winding start side of the second metal foil may overlap each other.

In the lithium primary battery (B), the outermost circumferential end portion E1out on the winding end side of the first metal foil and the innermost circumferential end portion E2inn on the winding start side of the second metal foil may be separated from each other. In this configuration, since there is no need to position the first metal foil and the second metal foil when the first metal foil and the second metal foil are connected, the negative electrode can be easily manufactured. Furthermore, since there is a gap between the outermost circumferential end portion E1out and the innermost circumferential end portion E2inn, the nonaqueous electrolyte is injected easily. Further, the gap between the outermost circumferential end portion E1out and the innermost circumferential end portion E2inn is disposed in a portion where the diameter of the electrode group is increased, whereby the roundness of the electrode group can be enhanced.

The lithium primary battery (B) may further include a negative electrode lead connected to a portion (i.e., gap portion) of the conductive sheet between the end E1out and the end E2inn. In this case, the negative electrode lead is preferably connected to the inner circumferential surface of the conductive sheet. With this configuration, since the negative electrode lead can be disposed in the gap portion, it is possible to suppress a decrease in roundness of the electrode group due to the negative electrode lead. The thickness of the negative electrode lead is preferably smaller than the average thickness of the second electrode.

The conductive sheet can be formed of a metal having conductivity. For example, the conductive sheet may be a metal foil made of a metal (single metal or alloy) containing at least one element selected from the group consisting of copper, iron, nickel, and zinc. An example of a metal containing iron is stainless steel. As the conductive sheet, a sheet made of one metal foil may be used. By using the metal foil (metal sheet), the first and second metal foils and the conductive sheet can be easily bonded by pressure welding. The method of connecting the first and second metal foils to the conductive sheet is not limited to pressure welding, and other known methods may be used.

Examples of the constituent elements of the lithium primary battery (B) according to the present embodiment will be described below, but the constituent elements of the lithium primary battery (B) are not limited to the following examples. Portions other than constituent elements essential for the lithium primary battery (B) according to the present embodiment are not limited as long as the effects of the present disclosure are obtained, and known configurations may be used.

The lithium primary battery (B) may include an outer package, and an electrode group and a non-aqueous electrolyte housed in the outer package. The electrode group can be formed by winding a strip-shaped positive electrode, a strip-shaped negative electrode, and a strip-shaped separator. The negative electrode may have a gap between the first metal foil and the second metal foil, but has a strip shape as a whole.

### (Positive Electrode)

The positive electrode may include a positive electrode current collector and a positive electrode mixture layer disposed on the positive electrode current collector. The positive electrode mixture layer contains a positive electrode active material. As the positive electrode active material, a positive electrode active material used in a known lithium primary battery may be used. For example, at least one selected from the group consisting of manganese oxide and graphite fluoride may be used as the positive electrode active material. Manganese dioxide may be used alone as the positive electrode active material. Alternatively, a mixture of a manganese oxide (for example, manganese dioxide) and another positive electrode active material (such as graphite fluoride) may be used as the positive electrode active material.

The lithium primary battery (B) containing manganese dioxide exhibits a relatively high voltage and is excellent in pulse discharge characteristics. The manganese dioxide may be electrolytic manganese dioxide. The manganese dioxide may be sintered electrolytic manganese dioxide obtained by sintering electrolytic manganese dioxide. The oxidation number of manganese contained in manganese dioxide is typically tetravalent, but is not limited to tetravalent, and some decrease is allowed. Examples of usable manganese oxides include MnO, Mn₃O₄, Mn₂O₃, and MnO₂. Manganese dioxide is generally used as a main component of the positive electrode active material.

The positive electrode mixture layer may contain other constituent elements (such as a binder and a conductive material) in addition to the positive electrode active material. Examples of the binder include fluororesins, rubbers, and acrylic resins. Examples of the conductive agent include natural graphite, artificial graphite, carbon black, and carbon fiber.

As the positive electrode current collector, a strip-shaped positive electrode current collector can be used. Examples of the form of the positive electrode current collector include a net-shaped current collector (e.g., an expanded metal and a punched metal) and a foil-shaped current collector. Examples of the material of the positive electrode current collector include stainless steel, aluminum, and titanium.

The method for forming the positive electrode is not limited, and the positive electrode may be formed by a known method. In an example formation method, first, a positive electrode mixture is prepared by mixing constituent elements of the positive electrode. At this time, a liquid medium (dispersion medium) may be mixed as necessary. Next, the positive electrode mixture is applied onto the positive electrode current collector to form a laminate including the positive electrode current collector and the positive electrode mixture layer formed on the positive electrode current collector. Next, as necessary, the positive electrode mixture layer is dried and the laminate is rolled. Thus, the positive electrode is formed. In the lithium primary battery (B), the positive electrode mixture layer is formed on both surfaces of the positive electrode current collector.

### (Negative Electrode)

As described above, the negative electrode includes the first metal foil, the second metal foil, and the conductive sheet. The first metal foil has a strip shape. The negative electrode has a strip shape as a whole, but there may be a gap between the first metal foil and the second metal foil.

The planar shape of the first metal foil and the planar shape of the second metal foil are usually rectangular. The width W1 of the first metal foil and the width W2 of the second metal foil are preferably the same or substantially the same as each other. Their ratio W2/W1 may be in the range 0.9 to 1.1.

The first metal foil and the second metal foil are arranged side by side along the longitudinal direction of the negative electrode. The first metal foil generally constitutes a portion of the negative electrode other than the outermost circumference. The second metal foil generally constitutes the outermost circumference of the negative electrode. That is, the outer circumferential end of the second metal is the outer circumferential end of the negative electrode. At least a part of the inner circumferential surface of the outermost circumference of the negative electrode faces the outer circumferential surface of the outermost circumference of the positive electrode with the separator interposed therebetween. The negative electrode is present on the outer side of the innermost circumferential end portion on the winding start side of the outermost circumference of the positive electrode and on the outer side of the outermost circumferential end portion on the winding end side of the outermost circumference of the positive electrode with the separator interposed therebetween.

As the first and second metal foils, a lithium metal foil or a lithium alloy foil can be used. Alternatively, a foil composed of a lithium layer and a lithium alloy layer may be used for the first and second metal foils. The composition of the first metal foil and the composition of the second metal foil are usually the same as each other, but may be different from each other. The first metal foil and the second metal foil may have the same composition as each other as a whole. Alternatively, the composition of the first metal foil and the second metal foil may vary depending on the location thereof. For example, in the first metal foil and the second metal foil, the composition of at least a part of the surface may be different from the composition of the other part.

Examples of the lithium alloy include a Li—Al alloy, a Li—Sn alloy, a Li—Ni—Si alloy, and a Li—Pb alloy. The content of the metal element other than lithium in the lithium alloy may be 15.0% by mass or less (for example, in the range of 0.05% by mass to 5.0% by mass) from the viewpoint of ensuring the discharge capacity and stabilizing the internal resistance.

A long tape including a resin substrate and an adhesive layer may be attached to at least one main surface of the negative electrode in the longitudinal direction of the negative electrode. The width of the tape may be 0.5 mm or more and 3 mm or less. The tape prevents the occurrence of current collection failure due to foil breakage of the negative electrode when the lithium component of the negative electrode is consumed due to a reaction at the end of discharge.

As the material of the resin substrate, for example, fluorine resin, polyimide, polyphenylene sulfide, polyether sulfone, polyolefin such as polyethylene and polypropylene, and polyethylene terephthalate can be used. Among them, polyolefin is preferable, and polypropylene is more preferable.

The adhesive layer contains, for example, at least one component selected from the group consisting of a rubber component, a silicone component, and an acrylic resin component. Specifically, synthetic rubber or natural rubber can be used as the rubber component. Examples of the synthetic rubber include butyl rubber, butadiene rubber, styrene-butadiene rubber, isoprene rubber, neoprene, polyisobutylene, acrylonitrile-butadiene rubber, a styrene-isoprene block copolymer, a styrene-butadiene block copolymer, and a styrene-ethylene-butadiene block copolymer. As the silicone component, an organic compound having a polysiloxane structure, or a silicone-based polymer can be used. Examples of the silicone-based polymer include a peroxide-curable silicone and an addition reaction-type silicone. As the acrylic resin component, a polymer containing an acrylic monomer such as acrylic acid, methacrylic acid, acrylic acid ester, and methacrylic acid ester can be used, and examples thereof include homopolymers or copolymers of acrylic monomers such as acrylic acid, methacrylic acid, methyl acrylate, methyl methacrylate, ethyl acrylate, ethyl methacrylate, propyl acrylate, propyl methacrylate, butyl acrylate, butyl methacrylate, octyl acrylate, octyl methacrylate, 2-ethylhexyl acrylate, and 2-ethylhexyl methacrylate. The adhesive layer may contain a crosslinking agent, a plasticizer, and a tackifier.

The negative electrode can be formed by connecting the first metal foil, the second metal foil, and the conductive sheet. These connections may be made by pressing them side by side in place. Alternatively, these connections may be performed by ultrasonic pressure welding or may be performed by caulking using brass.

### (Nonaqueous Electrolyte)

As the nonaqueous electrolyte, a solution obtained by dissolving a lithium salt in a nonaqueous solvent is used. The nonaqueous electrolyte may contain an additive as necessary. The nonaqueous solvent is not particularly limited, and an organic solvent that can be generally used for a nonaqueous electrolyte of a lithium primary battery may be used. For example, dimethyl ether, γ-butyrolactone, propylene carbonate, ethylene carbonate, or 1,2-dimethoxyethane may be used as the nonaqueous solvent. These organic solvents may be used alone or in combination of two or more.

From the viewpoint of improving the discharge characteristics of the lithium primary battery (B), the nonaqueous solvent may contain a cyclic carbonate ester having a high boiling point and a chain ether having a low viscosity even at a low temperature. The cyclic carbonate ester may include at least one selected from the group consisting of propylene carbonate (hereinafter, referred to as PC) and ethylene carbonate (hereinafter, referred to as EC), and may include propylene carbonate. The viscosity of the chain ether at 25° C. is preferably 1 mPa·s or less. The chain ether may include dimethoxyethane (hereinafter, referred to as DME). Here, the viscosity of the non-aqueous solvent is determined by measurement at a shear rate of 10,000 (1/s) at 25° C. using a trace sample viscometer m-VROC manufactured by RheoSense.

The lithium salt dissolved in the nonaqueous solvent is not particularly limited, and a lithium salt that can be generally used for a nonaqueous electrolyte of a lithium primary battery may be used. Examples of the lithium salt include LiCF₃SO₃, LiClO₄, LiBF₄, LiPF₆, LiRaSO₃ (Ra is a fluorinated alkyl group having 1 to 4 carbon atoms), LiFSO₃, LiN (SO₂Rb) (SO₂Rc) (Rb and Rc are each independently a fluorinated alkyl group having 1 to 4 carbon atoms), LiN (FSO₂)₂, and LiPO₂F₂. These may be used alone or in combination of two or more. The total concentration of the lithium salt contained in the non-aqueous electrolyte may be in the range of 0.2 to 2.0 mol/L, in the range of 0.3 to 1.5 mol/L, or in the range of 0.4 to 1.2 mol/L.

The nonaqueous electrolyte may contain other constituent elements in addition to the constituent elements described above. For example, the nonaqueous electrolyte may contain an additive such as propane sultone or vinylene carbonate. A part of hydrogen groups of the additive may be substituted with a hydroxyl group, a halogen group, or an alkyl group. These additives may be used alone or in combination of two or more. The total concentration of the additives contained in the nonaqueous electrolyte may be in the range of 0.003 to 5 mol/L (for example, in the range of 0.003 to 3 mol/L).

### (Separator)

The separator is not particularly limited. For example, a porous sheet formed of an insulating material having resistance to the internal environment of the lithium primary battery (B) can be used as the separator. Examples of the separator include a nonwoven fabric made of a synthetic resin, a microporous membrane made of a synthetic resin, and a laminate thereof.

Examples of the synthetic resin used for the nonwoven fabric include polypropylene, polyphenylene sulfide, and polybutylene terephthalate. Examples of the synthetic resin used for the microporous membrane include polyolefin resins (e.g., polyethylene, polypropylene, and ethylene-propylene copolymer). The microporous membrane may contain inorganic particles. The thickness of the separator may be 5 μm or more and 100 μm or less.

### (Method for Producing Lithium Primary Battery (B))

The method for producing the lithium primary battery (B) is not limited. The lithium primary battery (B) may be produced using a step used in a known production method. The lithium primary battery (B) can be produced by housing predetermined constituent elements (e.g., an electrode group and a nonaqueous electrolyte) in an outer package (for example, a battery case).

Hereinafter, an example of an embodiment according to the present disclosure will be specifically described with reference to the drawings. The embodiments described below can be modified based on the above description. Further, the matters described below may be applied to the above-described embodiment. In addition, in the embodiment described below, matters that are not essential to the invention according to the present disclosure may be omitted.

### First Embodiment

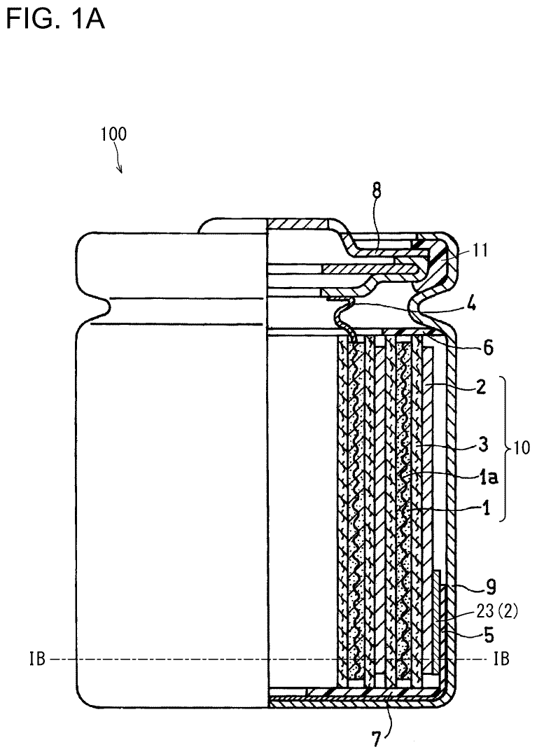

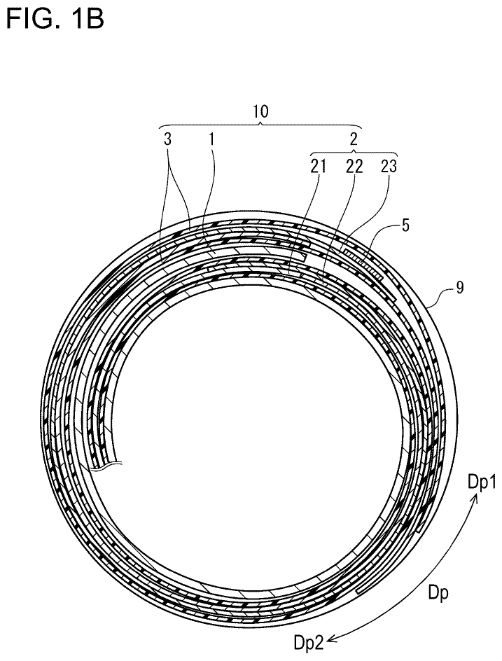

FIG. 1A is a partially exploded cross-sectional view schematically showing an example of the lithium primary battery (B). FIG. 1B shows an outer circumferential portion of electrode group 10 in a cross section taken along line IB-IB in FIG. 1A. FIG. 1B shows an example in which a separator 3 is disposed on the outermost circumference. A cylindrical lithium primary battery 100 shown in FIG. 1A includes a battery case 9, and an electrode group 10 and a non-aqueous electrolyte housed in the battery case 9. Electrode group 10 is formed by winding a positive electrode 1 and a negative electrode 2 in a circumferential direction Dp with a separator 3 interposed therebetween.

An annular groove is formed in the vicinity of the opening end of the battery case 9. The open end of the battery case 9 is sealed with a sealing plate 8 and a gasket 11 disposed above the groove. The sealing plate 8 and the positive electrode current collector 1a of the positive electrode 1 are connected by a positive electrode lead 4. A part of a negative electrode lead 5 is connected to a conductive sheet 23 (the negative electrode 2). Another part of the negative electrode lead 5 is connected to the battery case 9. An upper insulating plate 6 and a lower insulating plate 7 are disposed above and below the electrode group to prevent an internal short circuit. The positive electrode 1 includes a positive electrode mixture layer disposed on a positive electrode current collector 1a.

The negative electrode 2 is the above-described negative electrode. The negative electrode 2 includes a first metal foil 21, a second metal foil 22, and the conductive sheet 23. As shown in FIG. 1B, at least a part of the outer circumferential surface of the outermost circumference of the positive electrode 1 and at least a part of the inner circumferential surface of the second metal foil 22 face each other with the separator 3 interposed therebetween. The conductive sheet 23 is connected to at least the outer circumferential surface of the outermost circumferential portion on the winding end side of the first metal foil 21 and the outer circumferential surface of the second metal foil 22. Examples of the form of the negative electrode 2 include forms described in Examples.

### (Notes)

The following techniques are disclosed by the above description.

### (Technique 1)

A cylindrical lithium primary battery comprising:
an electrode group formed by winding a positive electrode, a negative electrode, and a separator in a circumferential direction with the separator disposed between the positive electrode and the negative electrode,
wherein
an outermost circumference of the negative electrode is disposed outside an outermost circumference of the positive electrode in the electrode group, and
the negative electrode includes a first metal foil, a second metal foil, and a conductive sheet,
each of the first metal foil and the second metal foil is made of lithium metal or a lithium alloy,
a length of the second metal foil in the circumferential direction is shorter than a length of the first metal foil in the circumferential direction; and
a thickness T2 of the second metal foil is smaller than a thickness T1 of the first metal foil,
a ratio T2/T1 of the thickness T2 to the thickness T1 is 0.30 or more,
the first metal foil and said second metal foil are arranged side by side in the circumferential direction so that the first metal foil includes a first innermost circumferential end portion and a first outermost circumferential end portion and the second metal foil includes a second innermost circumferential end portion and a second outermost circumferential end portion,
at least a part of the outermost circumference of the negative electrode is formed of the second metal foil,
the conductive sheet is connected to an outer circumferential surface of the first outermost circumferential end portion of the first metal foil and an outer circumferential surface of the second innermost circumferential end portion of the second metal foil on a winding start side, and
at least a part of the outermost circumference of the positive electrode faces the second metal foil with the separator disposed therebetween.

### (Technique 2)

The cylindrical lithium primary battery of Technique 1, wherein the ratio T2/T1 is 0.80 or less.

### (Technique 3)

The cylindrical lithium primary battery according to Technique 1 or 2, wherein
a ratio L2a/Lout of a length L2a of a portion of the second metal foil facing the outermost circumference of the positive electrode with the separator interposed therebetween to a length Lout of the outermost circumference of the positive electrode is 0.5 or more, and
a ratio L2/Lout of a length L2 of the second metal foil to the length Lout is 1.5 or less.

### (Technique 4)

The cylindrical lithium primary battery of any one of Techniques 1 to 3, wherein the first outermost circumferential end portion of the first metal foil and the second innermost circumferential end portion of the second metal foil overlap each other.

### (Technique 5)

The cylindrical lithium primary battery of any one of Techniques 1 to 3, wherein the first outermost circumferential end portion of the first metal foil and the second innermost circumferential end portion of the second metal foil are separated from each other.

### (Technique 6)

The cylindrical lithium primary battery according to Technique 5, further comprising a negative electrode lead connected to a portion of the conductive sheet between the first outermost circumferential end portion of the first metal foil and the second innermost circumferential end portion of the second metal foil.

### (Technique 7)

The cylindrical lithium primary battery of any one of Techniques 1 to 6, wherein the conductive sheet is made of copper or a copper alloy.

### EXAMPLES

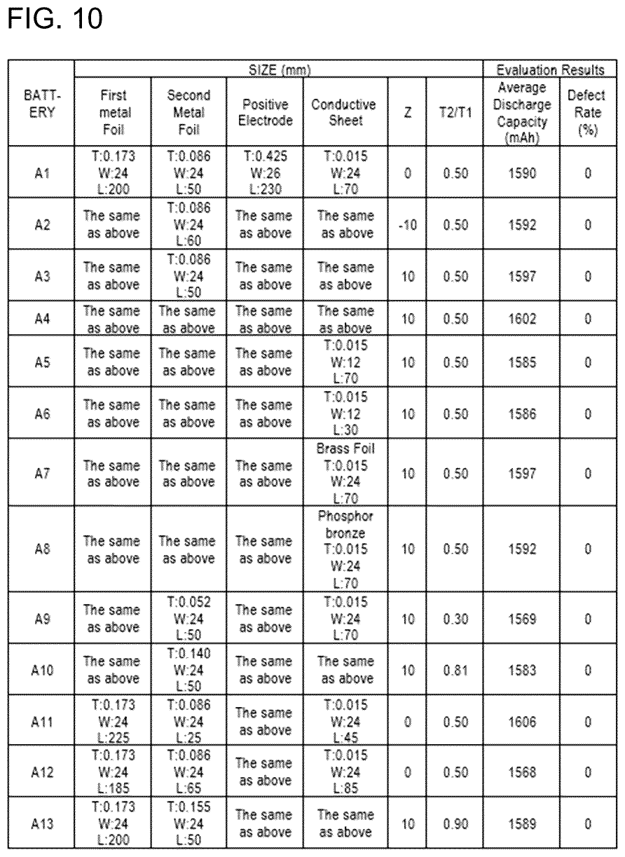

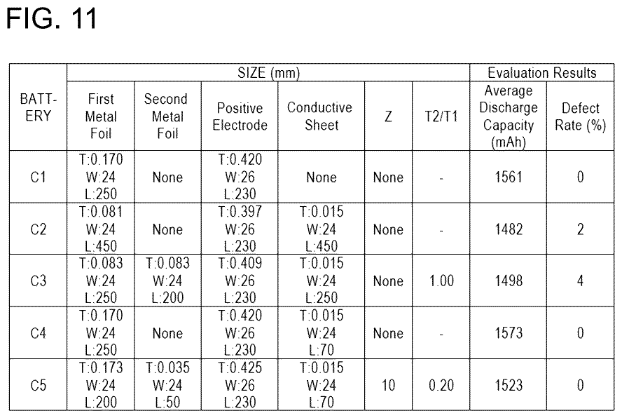

Hereinafter, the present disclosure will be specifically described based on examples, but the present disclosure is not limited to the following examples. FIGS. 10 and 11 are diagrams showing evaluation results of the examples of the cylindrical lithium primary battery according to the embodiment.

In the examples, a plurality of lithium primary batteries having different negative electrodes were produced and evaluated. First, a battery A1 was fabricated by the following procedure.

### (Battery A1)

### (1) Formation of Negative Electrode NA1

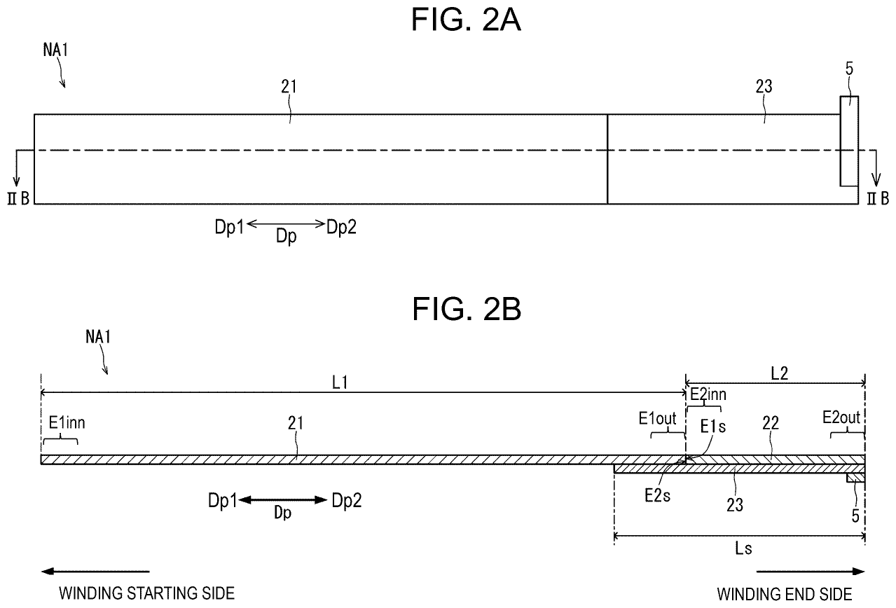

A top view of the formed negative electrode NA1 is shown in FIG. 2A. FIG. 2B is a cross-sectional view taken along line IIB-IIB of FIG. 2A. FIG. 2B shows a length L1 of the first metal foil 21, a length L2 of the second metal foil 22, a length Ls of the conductive sheet 23, an inner circumferential direction Dp1, which is the winding start side, and an outer circumferential direction Dp2, which is the winding end side. Each of the length L1, the length L2, and the length Ls is a length in the circumferential direction Dp of the electrode group. Also in the following drawings, the left side is the inner circumferential side, which is the winding start side, and the right side is the outer circumferential side, which is the winding end side.

In the production of the negative electrode NA1, first, the first metal foil 21 and the second metal foil 22 were arranged so that the end surface 21e of the outermost circumferential end portion E1out on the winding end side of the first metal foil 21 and the end surface 22e of the innermost circumferential end portion E2inn on the winding start side of the second metal foil 22 abutted each other, and the conductive sheet 23 was disposed so as to cover a part of the outer circumferential surface of the first metal foil 21 and the outer circumferential surface of the second metal foil 22. Then, the first metal foil 21, the second metal foil 22, and the conductive sheet 23 were connected by pressing them together. In this manner, the negative electrode NA1 was formed. In the negative electrode NA1, the distance Z between the end surface 21e and the end surface 22e is 0 mm.

Next, the negative electrode lead 5 was connected to the outer circumferential surface of the conductive sheet 23 of the negative electrode NA1. As the first and second metal foils, Li—Al alloy foils (Al content: 0.3% by mass) having sizes shown in FIG. 10 were used. As the conductive sheet, a copper foil having a size shown in FIG. 10 was used. As the negative electrode lead, a Ni foil (thickness: 70 μm) cut into a predetermined size (width: 3 mm, length: 25 mm) was used.

### (2) Formation of Positive Electrode

A positive electrode mixture was prepared by mixing 92 parts by mass of manganese dioxide as a positive electrode active material, 3 parts by mass of Ketjen black as a conductive agent, and 5 parts by mass of polytetrafluoroethylene as a binder.

Next, the positive electrode mixture was applied to both surfaces of a positive electrode current collector. As the positive electrode current collector, an expanded metal (thickness: 0.1 mm) made of ferritic stainless steel (SUS444) was used. The positive electrode mixture was applied so as to fill the pores of the expanded metal. Thereafter, the expanded metal coated with the positive electrode mixture was rolled by roll pressing, and then cut into a predetermined size. Thus, a positive electrode including the positive electrode current collector and the positive electrode mixture layer held on the positive electrode current collector was obtained. The size of the positive electrode was 230 mm in length, 26 mm in width, and 0.425 mm in thickness. Next, a portion of the positive electrode mixture layer was removed to expose the positive electrode current collector, and a positive electrode lead was welded to the exposed portion.

### (3) Preparation of Nonaqueous Electrolyte

First, propylene carbonate (PC) and 1,2-dimethoxyethane (DME) were mixed at a volume ratio of 1:1 to obtain a nonaqueous solvent. LiCF₃SO₃ was dissolved in the nonaqueous solvent to a concentration of 0.5 mol/L to prepare a nonaqueous electrolyte.

### (4) Assembly of Cylindrical Cells

The positive electrode, the negative electrode (negative electrode NA1), and the separator were wound such that the separator was disposed between the positive electrode and the negative electrode, thereby forming a cylindrical electrode group. At this time, the electrode group was formed such that the outermost circumference of the negative electrode was located outside the outermost circumference of the positive electrode. In addition, the electrode group was formed such that the outermost circumferential end portion on the winding end side of the positive electrode and the outermost circumferential end portion on the winding end side of the negative electrode faced each other with the separator interposed therebetween (the same applies to the batteries A2 to A13). As the separator, a microporous film (thickness: 25 μm) made of polyethylene was used. In the electrode group, the length Lout of the outermost circumference of the positive electrode was about 50 mm. The ratio L2a/Lout of the length L2a (about 50 mm) of the portion of the second metal foil facing the outermost circumference of the positive electrode with the separator interposed therebetween to the length Lout (about 50 mm) of the outermost circumference of the positive electrode was 1.0. The ratio L2/Lout of the length L2 (50 mm) of the second metal foil to the length Lout was 1.0.

Next, the electrode group was inserted into a bottomed cylindrical battery case with a ring-shaped lower insulating plate 7 disposed at the bottom thereof. Next, the negative electrode lead was welded to the inner bottom surface of the battery case. Next, a ring-shaped upper insulating plate was disposed above the electrode group. Next, a ring-shaped groove was formed in the vicinity of the open end of the battery case. Next, the positive electrode lead was welded to the sealing plate. Next, the nonaqueous electrolyte was placed in the battery case, and then the opening of the battery case was sealed with a sealing plate and a gasket. Thus, a battery A1 (cylindrical lithium primary battery) was produced.

### (Battery A2)

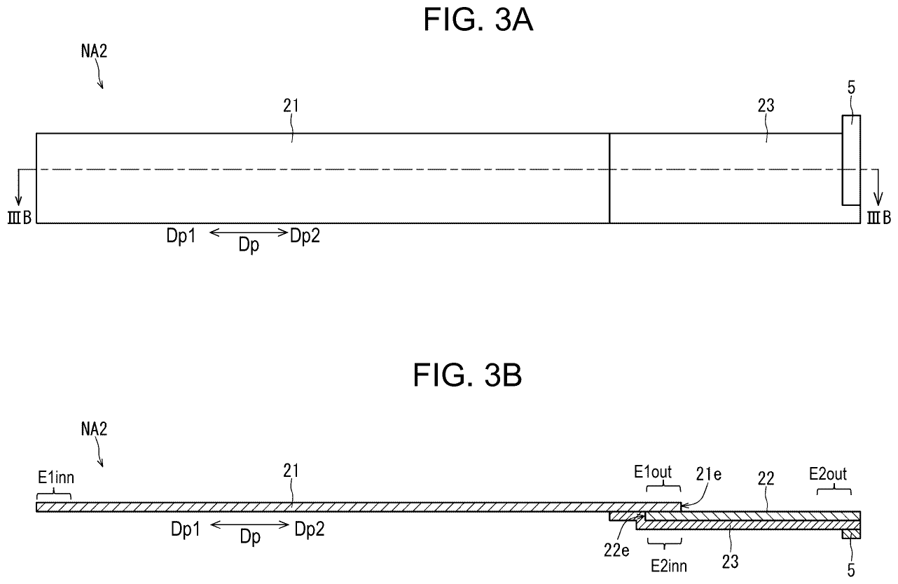

A battery A2 was produced by the same method and under the same conditions as in the production of the battery A1, except that the configuration of the negative electrode was changed. In the production of the battery A2, a negative electrode NA2 was produced using constituent members having sizes shown in FIG. 10. A top view of negative electrode NA2 is shown in FIG. 3A. FIG. 3B is a cross-sectional view taken along line IIIB-IIIB of FIG. 3A. In the negative electrode NA2, the distance Z between the end surface 21e and the end surface 22e was set to be −10 mm. Here, Z being negative indicates that the first metal foil and the second metal foil overlap each other. That is, in the negative electrode NA2, the overlapping length of the first metal foil and the second metal foil was set to be 10 mm.

### (Battery A3)

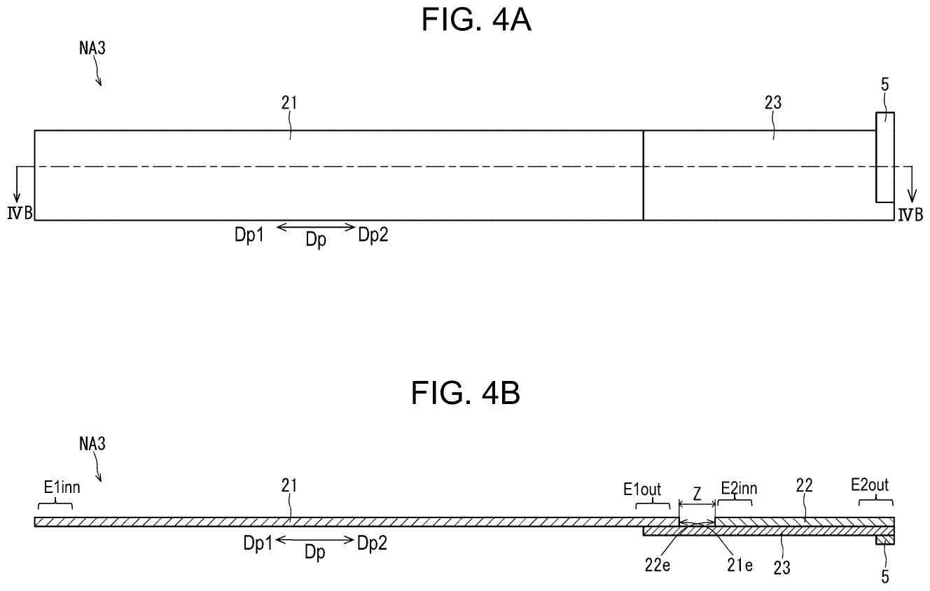

A battery A3 was produced by the same method and under the same conditions as in the production of the battery A1, except that the configuration of the negative electrode was changed. In the production of the battery A3, a negative electrode NA3 was produced using constituent members having sizes shown in FIG. 10. A top view of the negative electrode NA3 is shown in FIG. 4A. FIG. 4B is a cross-sectional view taken along line IVB-IVB in FIG. 4A. In the negative electrode NA3, the distance Z between the end surface 21e and the end surface 22e was set to be 10 mm.

### (Battery A4)

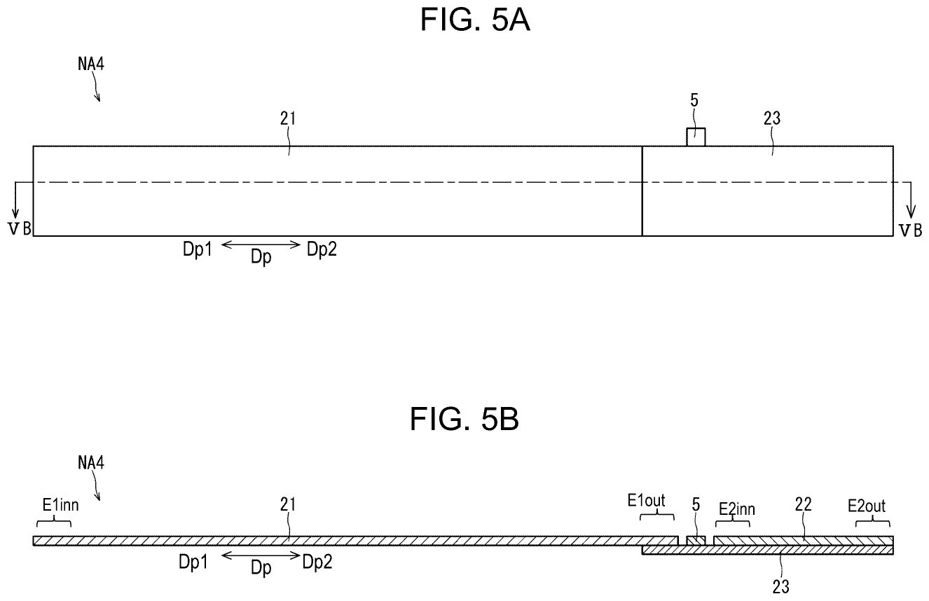

A battery A4 was produced by the same method and under the same conditions as in the production of the battery A3, except that the position at which the negative electrode lead was connected was changed. A top view of the produced negative electrode NA4 is shown in FIG. 5A. FIG. 5B is a cross-sectional view taken along line VB-VB of FIG. 5A.

### (Battery A5)

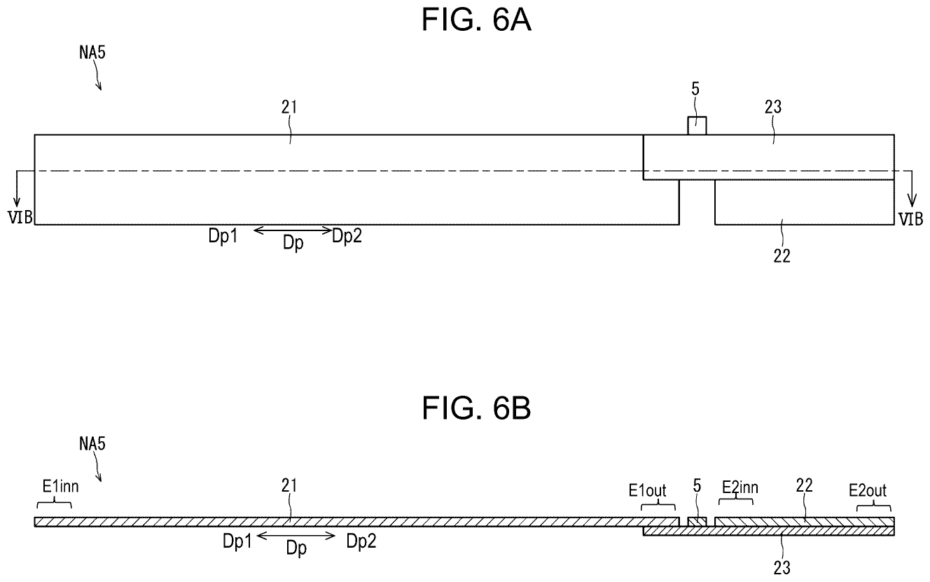

A battery A5 was produced by the same method and under the same conditions as in the production of the battery A4, except that the width Ws of the conductive sheet was 12 mm. A top view of the produced negative electrode NA5 is shown in FIG. 6A. FIG. 6B is a cross-sectional view taken along line VIB-VIB in FIG. 6A.

### (Battery A6)

A battery A6 was produced by the same method and under the same conditions as in the production of the battery A5, except that the length Ls of the conductive sheet was 30 mm.

### (Battery A7)

A battery A7 was produced by the same method and under the same conditions as in the production of the battery A4, except that the material of the conductive sheet was changed from copper to brass.

### (Battery A8)

A battery A8 was produced by the same method and under the same conditions as in the production of the battery A4, except that the material of the conductive sheet was changed from copper to phosphor bronze.

### (Batteries A9, A10, A13, and C5)

Batteries A9, A10, A13, and C5 were produced in the same manner and under the same conditions as in the production of Battery A4, except that the thickness T2 of the second metal foil was changed as shown in FIG. 10.

### (Batteries A11 and A12)

Batteries A11 and A12 were produced in the same manner and under the same conditions as in the production of Battery A1, except that the sizes of the first metal foil, the second metal foil, and the conductive sheet were changed as shown in FIG. 10.

### (Battery C1)

A battery C1 was produced by the same method and under the same conditions as in the production of the battery A1, except that a negative electrode formed only of the first metal foil having the size shown in FIG. 11 was used and the size of the positive electrode was changed to the size shown in FIG. 11. For the first metal foil, the same Li—Al alloy as the first metal foil used in the battery A1 was used (the same applies to the production of the following batteries).

### (Battery C2)

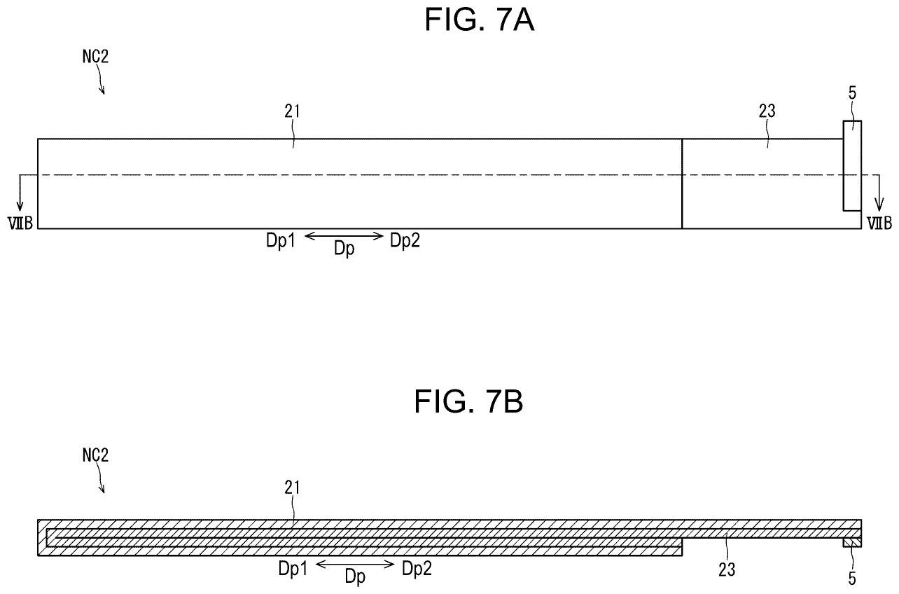

A battery C2 was produced by the same method and under the same conditions as in the production of the battery A1, except that the configuration of the negative electrode was changed and the size of the positive electrode was changed to the size shown in FIG. 11. FIG. 7A shows a top view of the formed negative electrode NC2. FIG. 7B is a cross-sectional view taken along line VIIB-VIIB of FIG. 7A. In the formation of the negative electrode NC2, first, the first metal foil 21 having the size shown in FIG. 11 and a copper foil (conductive sheet 23) having the same size as the first metal foil 21 were stacked and pressed to obtain a laminate. The obtained laminate was bent so that the copper foils were in contact with each other, thereby forming a negative electrode NC2. The length of the negative electrode NC2 was 250 mm. That is, the length of the portion where the laminates were stacked was 200 mm.

### (Battery C3)

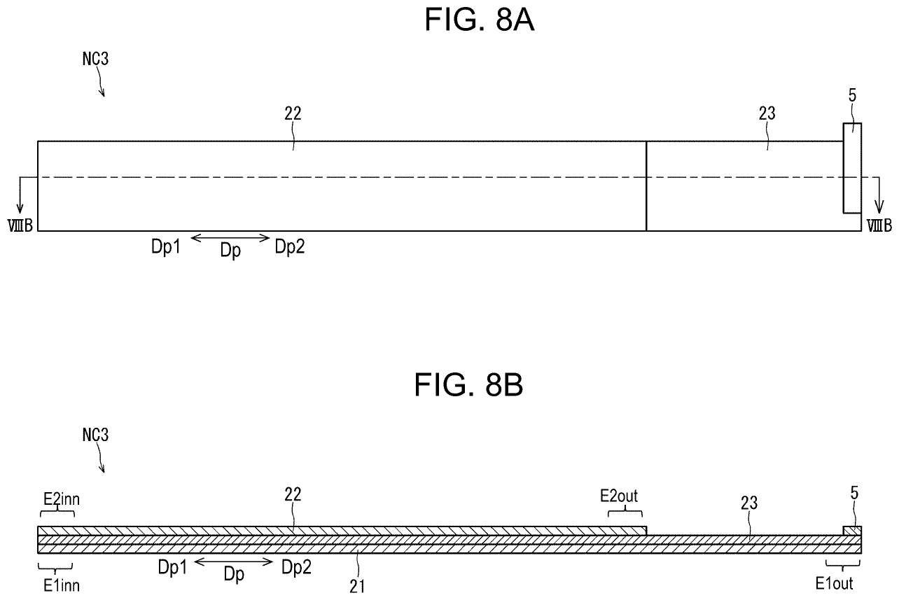

A battery C3 was produced by the same method and under the same conditions as in the production of the battery A1, except that the configuration of the negative electrode was changed and the size of the positive electrode was changed to the size shown in FIG. 10. FIG. 8A shows a top view of the formed negative electrode NC3. FIG. 8B is a cross-sectional view taken along line VIIIB-VIIIB of FIG. 8A. The negative electrode NC3 was formed by stacking and pressing the first metal foil 21, the second metal foil 22, and a copper foil (conductive sheet 23). Their sizes are shown in FIG. 11.

### (Battery C4)

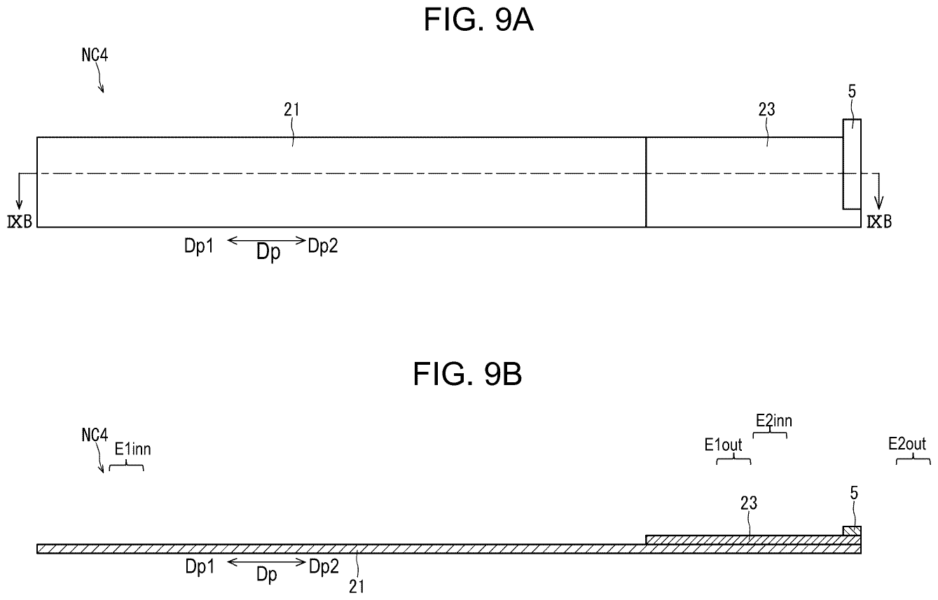

A battery C4 was produced by the same method and under the same conditions as in the production of the battery A1, except that the configuration of the negative electrode was changed and the size of the positive electrode was changed to the size shown in FIG. 10. A top view of the formed negative electrode NC4 is shown in FIG. 9A. FIG. 9B is a cross-sectional view taken along line IXB-IXB in FIG. 9A. The negative electrode NC4 was formed by stacking and pressing the first metal foil 21 and a copper foil (conductive sheet 23). Their sizes are shown in FIG. 11.

One hundred of each of the above batteries were produced, and the defect rate during the production was determined from the number of defective batteries. Causes of battery defects include winding misalignment during the formation of the electrode group and current leakage.

For each of the above batteries, the discharge capacities of five normal batteries produced were measured. The five measured discharge capacities were arithmetically averaged to determine the average discharge capacity of each battery.

A part of the manufacturing conditions of the negative electrode and the evaluation results are shown in FIGS. 10 and 11. In FIGS. 10 and 11, T means thickness, W means width, and L means length (length in the circumferential direction Dp). As described above, Z is the distance between the end surface 21e and the end surface 22e, and Z being negative means that the first metal foil and the second metal foil overlap each other. FIG. 10 also shows the ratio T2/T1 of the thickness T2 of the second metal foil to the thickness T1 of the first metal foil.

The batteries A1 to A13 are lithium primary batteries (B) according to the present disclosure. The batteries C1 to C5 are batteries of comparative examples. As shown in FIGS. 10 and 11, the batteries A1 to A13 had a low defect rate during the production and a high average discharge capacity. In the batteries C2 and C3, the thickness of the positive and negative electrodes, that is, the amount of the active material is decreased by the amount of the conductive sheet, and thus the capacity is decreased. From the viewpoint of the results of the batteries A9 and C5, the ratio T2/T1 needs to be 0.30 or more in order to improve the discharge capacity. When the batteries A4, A10, and A13 are compared to each other, the average discharge capacities are substantially the same as each other. Therefore, the ratio T2/T1 is preferably 0.81 or less (for example, 0.80 or less) in consideration of the amount of lithium used and the space utilization inside the battery.

### INDUSTRIAL APPLICABILITY

The present disclosure is applicable to a cylindrical lithium primary battery.

### REFERENCE SIGNS LIST

1 positive electrode
2 negative electrode
3 separator
5 negative electrode lead
8 sealing plate
9 battery case
10 electrode group
21 first metal foil
22 second metal foil
23 conductive sheet
100 cylindrical lithium primary battery

1. A cylindrical lithium primary battery, comprising:
an electrode group formed by winding a positive electrode, a negative electrode, and a separator in a circumferential direction with the separator disposed between the positive electrode and the negative electrode,
wherein
in the electrode group, an outermost circumference of the negative electrode is disposed outside an outermost circumference of the positive electrode,
the negative electrode includes a first metal foil, a second metal foil, and a conductive sheet,
each of the first metal foil and the second metal foil is made of a lithium metal or a lithium alloy,
a length of the second metal foil in the circumferential direction is shorter than a length of the first metal foil in the circumferential direction,
a thickness T2 of the second metal foil is smaller than a thickness T1 of the first metal foil,
a ratio T2/T1 of the thickness T2 to the thickness T1 is 0.30 or more,
the first metal foil and the second metal foil are disposed side by side in the circumferential direction such that the first metal foil has a first innermost circumferential end portion and a first outermost circumferential end portion and the second metal foil has a second innermost circumferential end portion and a second outermost circumferential end portion,
at least a part of the outermost circumference of the negative electrode is formed of the second metal foil,
the conductive sheet is connected to an outer circumferential surface of the first outermost circumferential end portion of the first metal foil and an outer circumferential surface of the second innermost circumferential end portion of the second metal foil, and
at least a part of the outermost circumference of the positive electrode faces the second metal foil with the separator interposed therebetween.

2. The cylindrical lithium primary battery according to claim 1, wherein the ratio T2/T1 is 0.80 or less.

3. The cylindrical lithium primary battery according to claim 1, wherein
a ratio L2a/Lout of a length L2a of a portion of the second metal foil facing the outermost circumference of the positive electrode with the separator interposed therebetween to a length Lout of the outermost circumference of the positive electrode is 0.5 or more, and
a ratio L2/Lout of a length L2 of the second metal foil to the length Lout is 1.5 or less.

4. The cylindrical lithium primary battery according to claim 1, wherein the first outermost circumferential end portion of the first metal foil and the second innermost circumferential end portion of the second metal foil overlap each other.

5. The cylindrical lithium primary battery according to claim 1, wherein the first outermost circumferential end portion of the first metal foil and the second innermost circumferential end portion of the second metal foil are separated from each other.

6. The cylindrical lithium primary battery according to claim 5, further comprising a negative electrode lead connected to a portion of the conductive sheet between the first innermost circumferential end portion of the first metal foil and the second innermost circumferential end portion of the second metal foil.

7. The cylindrical lithium primary battery according to claim 1, wherein the conductive sheet is made of copper or a copper alloy.
